(19) United States
(12) Patent Application Publication
(10) Pub. No.: US 2008/0237329 A1
(43) Pub. Date: Oct. 2, 2008

(54) PACKAGING FOR DETECTOR TUBES

(75) Inventors: Gero VORNBAEUMEN, Lubeck (DE); Andreas MUELLER, Lubeck (DE); Frank ARNOLD, Lubeck (DE); Bernd SIEMENSMEYER, Hamberge (DE)

Correspondence Address: MCGLEW & TUTTLE, PC, P.O. BOX 9227, SCARBOROUGH STATION, SCARBOROUGH, NY, 10510-9227, US

(73) Assignee: DRÄGER SAFETY AG & CO. KGAA, Lubeck (DE)

(21) Appl. No.: 11/776,153

(22) Filed: Jul. 11, 2007

(30) Foreign Application Priority Data
Aug. 11, 2006 (DE) 10 2006 037 726.5

(51) Int. Cl. B65D 5/38; B01J 19/00

(52) U.S. Cl. 229/125.125; 422/83

(57) ABSTRACT

A detector tube packaging is provided for packaging detector tubes with tips. The packaging includes a pushing insert for receiving a plurality of detector tubes located next to one another and a container for receiving the pushing insert via a first side of the container. A seal element may connect the pushing insert to the container. The seal may be broken to remove the insert and may be applied adjacent to or at a first side of the container. A detector tube opener is provided at another side of the container. The detector tube opener has openings corresponding to the number and the spacing of the detector tubes. The openings are located next to each other with each opening having an opening diameter substantially corresponding to a diameter of the tips of the detector tubes.

### CROSS REFERENCE TO RELATED APPLICATIONS

This application claims the benefit of priority under 35 U.S.C. § 119 of German Patent Application DE 10 2006 037 726.5 filed Aug. 11, 2006, the entire contents of which are incorporated herein by reference.

### FIELD OF THE INVENTION

The present invention pertains to a packaging for detector tubes, which is provided, in general, with tips, which are cut off before such a detector tube is used for measurement in order to make possible the entry of the gas to be measured into the detector tube.

### BACKGROUND OF THE INVENTION

It is known that, for example, five detector tubes containing different reagents may be arranged in a rubber cuff as a test set for different gases to be measured or toxic gases for so-called simultaneous tests for a semiquantitative measurement with detector tubes, especially DRÄGER® detector tubes. The rubber cuff with the detector tubes has hitherto been packaged in a cardboard box.

The air to be tested is drawn via an adapter simultaneously through the detector tubes with a gas detector pump. The measured concentrations are stated as a multiple of a limit value. However, the detector tubes must be scribed at their tips by means of a ceramic cutter before the measurement and then broken open manually. The described prior-art operation of opening the detector tube is critical for simple, intuitive handling. This is especially true of emergency uses, and the opening operation cannot be reproduced with constant quality, so that errors in measurement are possible. In addition, there is a risk that the ceramic cutter and the broken detector tube ends cause injuries if handling is not careful. On the other hand, handling is difficult with heavy protective or work gloves and not intuitive because the cut must be directed in a certain way. In addition, broken glass that becomes free may be a source of danger.

### SUMMARY OF THE INVENTION

The indicated drawbacks shall be avoided by the present invention. Thus, the object of the present invention is to provide an improved packaging for detector tubes, which makes possible improved handling for making ready for the measurement.

According to the invention, a detector tube packaging is provided for packaging detector tubes with tips. The packaging includes a pushing insert for receiving a plurality of the detector tubes located next to one another and a container for receiving said pushing the insert via a first side of the container. A seal element may connect the pushing insert to the container. The seal may be broken to remove the insert and may be applied adjacent to or at a first side of the container. A detector tube opener is provided at another side of the container. The detector tube opener has openings corresponding to the number and the spacing of the detector tubes. The openings are located next to each other with each opening having an opening diameter substantially corresponding to a diameter of the tips of the detector tubes.

The tube opener may be bonded to the container on the other side of the container, the detector tube opener comprises a metallic or ceramic insert. The other side of the container with the detector tube opener may be arranged opposite in relation to the first side of the container.

The pushing insert may be provided with a strap, which forms the container wall on the first side of the container in the pushed-in state of the pushing insert in the container. The pushing insert may be equipped with webs for receiving the detector tubes in the correct position. The pushing insert may advantageously be formed essentially of a recyclable cellulose material.

The container may have a cuboid shape. The first side of the container and the other side of the container form the opposite smaller side faces of the cuboid container.

According to another aspect of the invention, a detector tube packaging arrangement is provided including a plurality of detector tubes with tips, a pushing insert for receiving the plurality of the detector tubes, with the detector tubes being located next to one another and a container for receiving the pushing insert via a first side of the container. A detector tube opener is provided at a second side of the container. The detector tube opener has openings corresponding to the number and the spacing of the detector tubes. The openings are located next to each other with each opening having an opening diameter sized to receive at least a portion of one of the tips of the detector tubes.

The packaging arrangement and the packaging may include a seal element for connecting the pushing insert to the container at a location adjacent to or at the first side of the container. The seal may be disposed to be broken to allow the pushing insert to slide out relative to the container.

A separate, additional cutting instrument is eliminated with the indicated packaging with integrated detector tube opener. The function of the previous rubber cuff is assumed now by an inexpensive and easier-to-handle pushing insert with webs made of special, recyclable cellulose.

The detector tubes are broken reliably at both ends together in one operation. All pieces of broken glass are retained in the packaging.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which the preferred embodiment of the invention is illustrated.

### BRIEF DESCRIPTION OF THE DRAWINGS

In the drawings:

FIG. 1 is a perspective view of a closed packaging;

FIG. 2 is a perspective view of the packaging just opened;

FIG. 3 is a perspective view of the pushing insert with the packaging opened;

FIG. 4 is a perspective view of the pushing insert with the detector tubes in the detector tube opener; and

FIG. 5 is an end view showing the tube opener bonded on the rear side of the packaging.

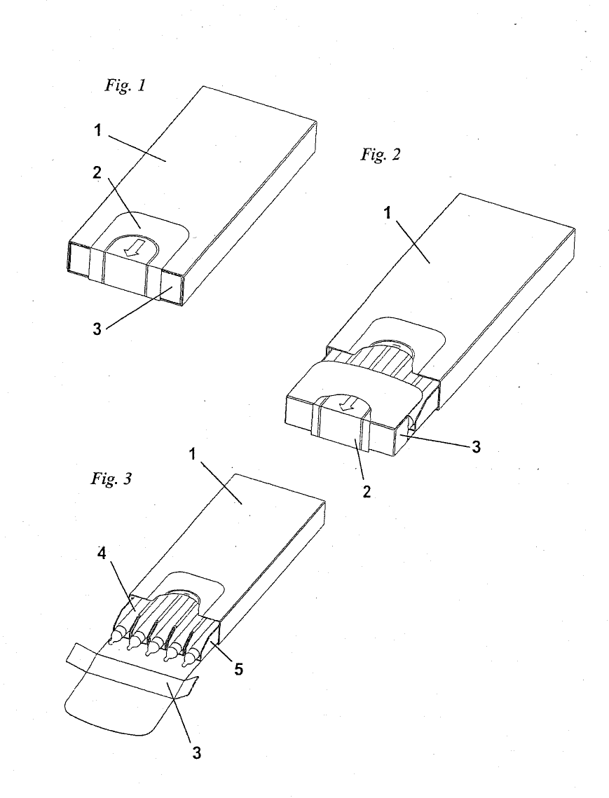

### DESCRIPTION OF THE PREFERRED EMBODIMENT

Referring to the drawings in particular, the packaging for detector tubes 4 has first an outer container 1, for example, one made of a cardboard material for receiving a pushing insert 3 for detector tubes 4. The pushing insert 3 is made especially of a recyclable material such as cellulose and is connected to the container 1 by means of a seal 2. The seal 2 can be cut and is returned to the manufacturer or the seller of the packaging with the detector tubes 4. The wall of the container is formed by a strap of the pushing insert 3 on the pushing-in or pushing-out side.

For use, the pushing insert 3 is pulled out of the container 1 while breaking the seal 2, see FIGS. 2 and 3. The pushing insert 3 is provided with webs 5 and is used as a protection for the transportation and for receiving, for example, five glass detector tubes 4, which are arranged next to each other and which are used for the selective detection of gases to be measured or toxic gases, in the correct position.

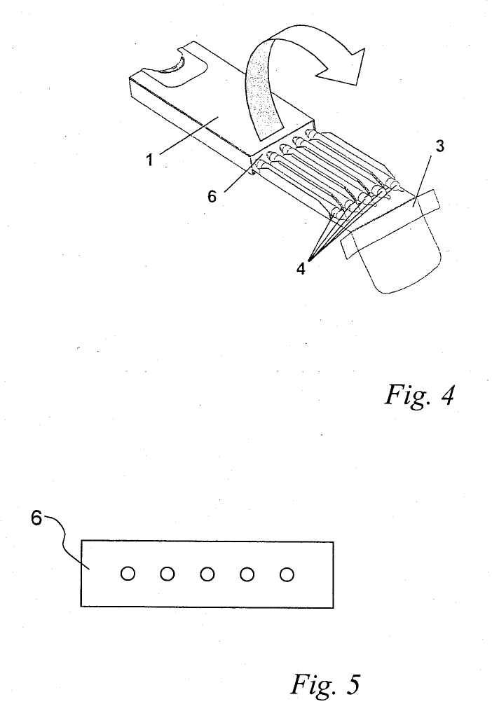

After the pushing insert 3 with the detector tubes 4 fixed between the webs 5 has been pulled out completely, this unit is inserted into the five complementary holes of a detector tube opener 6. The detector tube opener 6 is bonded on the rear side in the cardboard slipcase of the container 1 and designed as a rectangular tube according to this embodiment, in order to be broken open simultaneously by a bending motion indicated by the arrow in FIG. 4. The rectangular tube with the holes for receiving the tips of the detector tubes 4 is used as a detector tube opener 6. The broken-off glass tips of the detector tubes 4 remain inside the container 1 with the rectangular tube after the breaking operation, or, as an alternative, in a compartment between the detector tube opener 6 and an inner wall in the container 1.

While a specific embodiment of the invention has been shown and described in detail to illustrate the application of the principles of the invention, it will be understood that the invention may be embodied otherwise without departing from such principles.

What is claimed is:

1. A detector tube packaging for packaging detector tubes with tips, the packaging comprising:
a pushing insert for receiving a plurality of the detector tubes located next to one another;
a container for receiving said pushing insert via a first side of the container;
a seal element for connecting said pushing insert to said container, said seal being able to be broken adjacent to or at said first side of the container;
a detector tube opener provided at another side of said container, said detector tube opener having openings corresponding to the number and the spacing of said detector tubes, said openings being located next to each other with each opening having an opening diameter substantially corresponding to a diameter of said tips of said detector tubes.

2. A packaging in accordance with claim 1, wherein said detector tube opener is bonded to said container on said another side of said container, said detector tube opener comprising a metallic or ceramic insert.

3. A packaging in accordance with claim 1, wherein said another side of said container with said detector tube opener is arranged opposite in relation to said first side of said container.

4. A packaging in accordance with claim 1, wherein said pushing insert is provided with a strap, which forms the container wall on the first side of the container in a pushed-in state of said pushing insert in said container.

5. A packaging in accordance with claim 1, wherein said pushing insert is equipped with webs for receiving said detector tubes in the correct position.

6. A packaging in accordance with claim 5, wherein said pushing insert with said webs consists essentially of a recyclable cellulose material.

7. A packaging in accordance with claim 1, wherein said container has a cuboid shape and said first side of said container and said another side of said container form opposite smaller side faces of the cuboid container.

8. A detector tube packaging arrangement comprising:
a plurality of detector tubes with tips;
a pushing insert for receiving said plurality of the detector tubes, with said detector tubes being located next to one another;
a container for receiving said pushing insert via a first side of the container;
a seal element for connecting said pushing insert to said container at a location adjacent to or at said first side of the container, said seal element being disposed to be broken to allow said pushing insert to slide out relative to said container;
a detector tube opener provided at a second side of said container, said detector tube opener having openings corresponding to the number and the spacing of said detector tubes, said openings being located next to each other with each opening having an opening diameter sized to receive at least a portion of one of said tips of said detector tubes.

9. A packaging arrangement in accordance with claim 8, wherein said detector tube opener is bonded to said container on said second side of said container, said detector tube opener comprising a metallic or ceramic insert.

10. A packaging arrangement in accordance with claim 9, wherein said another side of said container with said detector tube opener is arranged opposite in relation to said first side of said container.

11. A packaging arrangement in accordance with claim 9, wherein said pushing insert is provided with a strap, which forms the container wall on said first side of said container in a pushed-in state of said pushing insert in said container.

12. A packaging arrangement in accordance with claim 9, wherein said pushing insert is equipped with webs for receiving said detector tubes in a position.

13. A packaging arrangement in accordance with claim 9, wherein said pushing insert with said webs consists essentially of a recyclable cellulose material.

14. A packaging arrangement in accordance with claim 9, wherein said container has a cuboid shape and said first side of said container and said another side of said container form said opposite smaller side faces of the cuboid container.

15. A detector tube packaging arrangement comprising:
a plurality of detector tubes with tips;
a pushing insert for receiving said plurality of detector tubes, with said detector tubes being located adjacent to one another;
a container for receiving said pushing insert via a first side of the container, said pushing insert being supported slidably relative to said container for moving between a fully inserted position to a removed position outside of said container;
a detector tube opener provided at a second side of said container, said detector tube opener having openings corresponding to the number and the spacing of said detector tubes, said openings being located next to each other with each opening having an opening diameter sized to receive at least a portion of one of said tips of said detector tubes.

16. A packaging arrangement in accordance with claim 15, wherein said detector tube opener is bonded to said container on said second side of said container and said another side of said container with said detector tube opener is arranged opposite in relation to said first side of said container.

17. A packaging arrangement in accordance with claim 15, further comprising;
a seal element for connecting said pushing insert to said container at a location adjacent to or at said first side of said container, said seal element being disposed to be broken to allow said pushing insert to slide out relative to said container wherein said pushing insert is provided with a strap, which forms the container wall on said first side of said container in said fully inserted position.

18. A packaging arrangement in accordance with claim 15, wherein said pushing insert is equipped with webs for receiving said detector tubes in a position and providing a spacing between said plurality of detector tubes to position each tip corresponding to a position of an opening based on the number and the spacing of said openings.

19. A packaging arrangement in accordance with claim 18, wherein said pushing insert with said webs consists essentially of a recyclable cellulose material.

20. A packaging arrangement in accordance with claim 15, wherein said container has a cuboid shape and said first side of said container and said another side of said container form opposite smaller side faces of the cuboid container.
